(19) United States
(12) Patent Application Publication
(10) Pub. No.: US 2021/0367500 A1
(43) Pub. Date: Nov. 25, 2021

(54) ADAPTIVE POWER CONTROL

(71) Applicant: Miot Limited, Hong Kong SAR (CN)

(72) Inventors: Ka Wai Ho, Kowloon (CN); Wan Tim Chan, Hong Kong SAR (CN); Ngai Wa Wong, New Territories (CN); Chiu Sing Celement Tse, Hong Kong SAR (CN)

(21) Appl. No.: 16/878,093

(22) Filed: May 19, 2020

(51) Int. Cl. H02M 1/08; H02M 3/07

(52) U.S. Cl. CPC H02M 1/08; H02M 2001/0045; H02M 3/07

(57) ABSTRACT

Disclosed herein is a method. An output voltage level is sensed. Determining if a power source delivers power to a system. If the output voltage is higher than a designed voltage threshold (Vh), then the power source will stop delivery of power to a circuit. If the output voltage is lower than another voltage threshold (Vl), the power source transfers power to the system until the output voltage reaches the designed voltage threshold (Vh).

### BACKGROUND

This disclosure relates to adaptive power control and, more particularly, to an adaptive power control circuit and method.

In general, for a power management unit (PMU), it is required to provide constant voltage (CV) or constant current (CC) depending on the output loading while the PMU needs to guarantee to function within its safety operation area without being damaged by over voltage, over current and over power. In order to save power, most of the PMU has shut down mode or standby mode. In shut down mode, only limited components inside the PMU are keep functioning. A long wake up time is expected for the PMU to return back to normal operating mode from shut down mode. On the other hand, standby mode is a state of the device that some core components keep functioning with less power consumption compared with normal operating mode. The main difference between shut down mode and standby mode is that when the device is in standby mode, it can be quickly resumed to normal operating mode in a short period of time, but the power consumption for standby mode is larger than shut down mode.

Most PMUs have built-in standby mode feature to reduce power consumption. However, they can only be triggered into standby mode by another controller or microcontroller (MCU). Accordingly, there is a need for providing highly efficient power control.

### SUMMARY

In accordance with one aspect of the disclosure, a method is disclosed. An output voltage level is sensed. Determining if a power source delivers power to a system. If the output voltage is higher than a designed voltage threshold (Vh), then the power source will stop delivery of power to a circuit. If the output voltage is lower than another voltage threshold (Vl), the power source transfers power to the system until the output voltage reaches the designed voltage threshold (Vh).

In accordance with another aspect of the invention, an adaptive power control circuit is disclosed. The adaptive power control circuit includes a sensing circuit, a voltage regulator connected to the sensing circuit; and a feedback network connected between the sensing circuit and the voltage regulator. The sensing circuit, the voltage regulator, and the feedback network are configured to cause the adaptive power control circuit to: sense an output voltage level; determine if a power source delivers power to a system. If the output voltage is higher than a designed voltage threshold (Vh), then the power source will stop delivery of power. If the output voltage is lower than another voltage threshold (Vl), the power source transfers power to the system until the output voltage reaches the designed voltage threshold (Vh).

### BRIEF DESCRIPTION OF THE DRAWINGS

The foregoing aspects and other features various exemplary embodiments of the invention are explained in the following description, taken in connection with the accompanying drawings, wherein:

FIG. 1 is a schematic of a core architecture for a DC power source;

FIG. 2 is a schematic of an alternate embodiment for a DC power source;

FIG. 3 illustrates key wave forms of the system shown in FIG. 2;

FIGS. 4A-4C show schematics of alternate embodiments for an AC power source;

FIGS. 5A-5C show schematics of alternate embodiments with power saving switches for an AC power source;

FIGS. 6A-6C show schematics of alternate embodiments with shunting power switches for an AC power source;

FIG. 7 is another illustration showing key wave forms;

FIGS. 8A-8C show schematics of further embodiments for a DC power source with alternate circuit topology;

FIGS. 9A-9C show schematics of further embodiments with power saving switches for an AC power source;

FIGS. 10A-10C show schematics of further embodiments with shunting power switches for an AC power source; and

FIG. 11 is a block diagram of a method incorporation features of the various embodiments.

### DETAILED DESCRIPTION

Referring to the figures, there are shown various views of exemplary embodiments incorporating features of the invention. Although the invention will be described with reference to the exemplary embodiment shown in the drawings, it should be understood that the invention can be embodied in many alternate forms of embodiments. In addition, any suitable size, shape or type of elements or materials could be used.

The various exemplary embodiments demonstrate architectures that features stable and smooth transition between power saving mode and normal operating mode and vice versa. The proposed architectures can be used for both DC power source and AC power source so as to minimize the standby power of the system while maintaining the functionality of the system in power saving mode.

According to various exemplary embodiments, an adaptive power control circuit will be present to eliminate the need of the controller or MCU to trigger the system to either standby mode or shut down mode. The proposed PMU can detect the status of the output and operate between power saving mode and normal operating mode stably and automatically. Moreover, the whole system is self-powered under power saving mode which enjoying low standby power while eliminate the disadvantage of long wake up time of shut down mode. Most importantly, traditional switching mode power supply (SMPS) cannot maintain high efficiency level over wide range of loading condition. Using the adaptive power control, the system can obtain high efficiency no matter what the loading condition is.

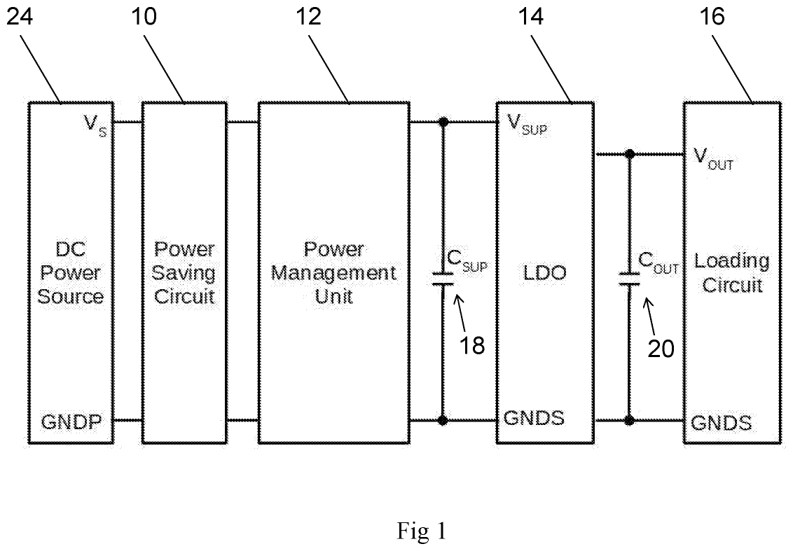

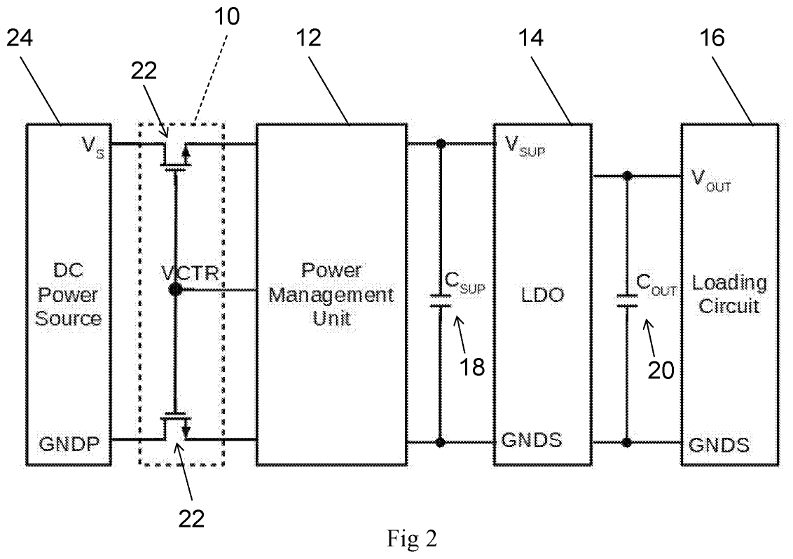

For different power sources, there are different architectures for the power saving circuit and circuit topology. However, the core architecture remains unchanged. The core architecture consists of a power saving circuit 10, a PMU 12, a low-dropout regulator (LDO) 14 and a loading circuit 16. This core architecture can be used in DC power source 24, as shown in FIG. 1. During startup, the initial condition of the power saving circuit allows the power to be delivered to the loading circuit 16. The supply voltage capacitor (C_{SUP}) 18 and the output capacitor (C_{OUT}) 20 is charging up to the designed voltage level, V_{DDH} and V_{LDO} respectively. When the supply voltage (V_{SUP}) reach the desired value, V_{DDH}, the power saving circuit will be activated by the adaptive power control unit. FIG. 2 shows one of the possible configurations of the power saving circuits which consists of two series switches 22. The switches 22 open the circuit between the power source 24 and the PMU 12 when the supply voltage reached V_{DDH} so that no more power is delivered to the PMU 12, the LDO 14 and the loading circuit 16. Because the power saving circuit is operating under its own supply voltage stored by C_{SUP} and C_{OUT}, the power saving mode is essentially a self-contained operating mode without the disadvantages of traditional power saving mode: long wake up time and limited circuit functionality. Also, due to the disconnection between the power source 24 and the PMU 12 by the power saving switches 22, no excess power is being wasted at power saving mode especially when the system consists of voltage clamping circuit or shunt regulator. The power consumption is mainly dissipated by the loading circuit stored in C_{OUT} and hence achieving high power efficiency over a wide range of loading condition. Most of the SMPS cannot maintain high efficiency over different loading condition, but our novel architecture can achieve high efficiency independent of the loading condition.

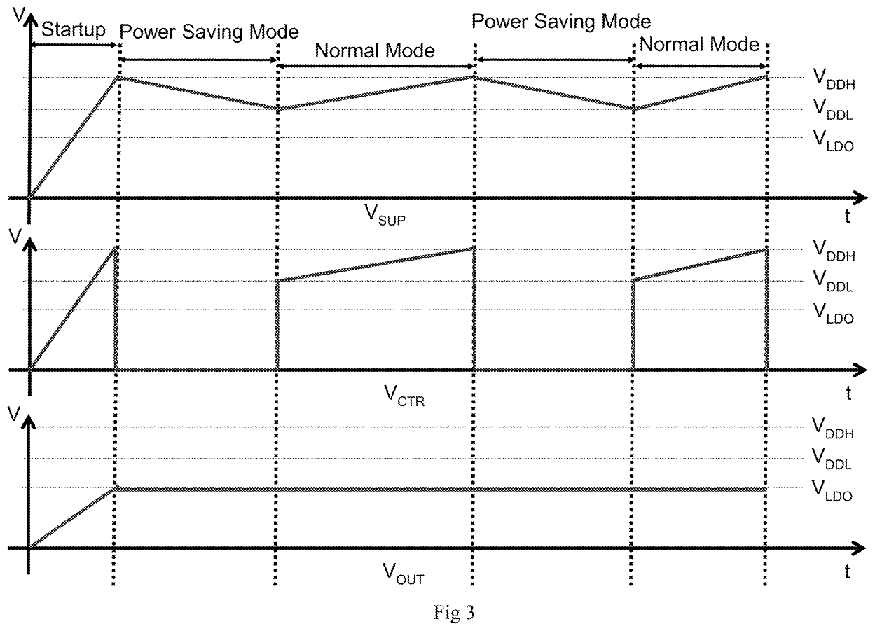

Because the power is kept dissipated by the PMU 12, the LDO 14 and the loading circuit 16, the supply voltage will keep decreasing and finally reach a triggered level, V_{DDL}. The power saving switches 22, in this series configuration, will be ON again by the sensing circuit and the adaptive power control unit in the PMU 12 so that the PMU 12 is now operating at normal mode. The power will then deliver from the power source to the C_{SUP} of the PMU again. Therefore, C_{SUP} and C_{OUT} gain power and recharging up again. The negative feedback cycle of the adaptive power control completed when the supply voltage reached V_{DDH} and trigger the system to enter into power saving mode again. FIG. 3 shows the key waveforms of the system in FIG. 2. Similar to traditional SMPS, the ripple voltage between V_{DDH} and V_{DDL} is minimized by the LDO so that the loading circuit can be any application with low ripple voltage requirement.

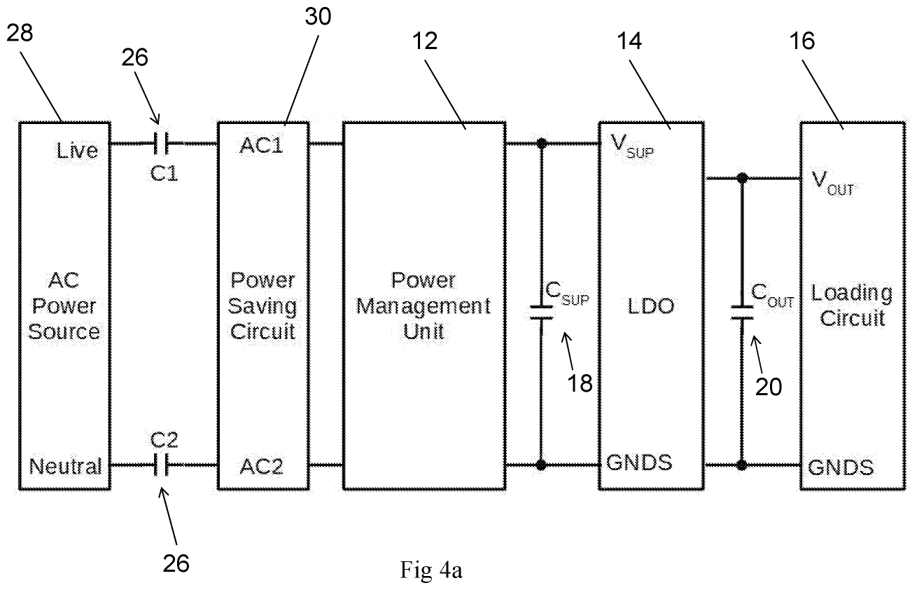

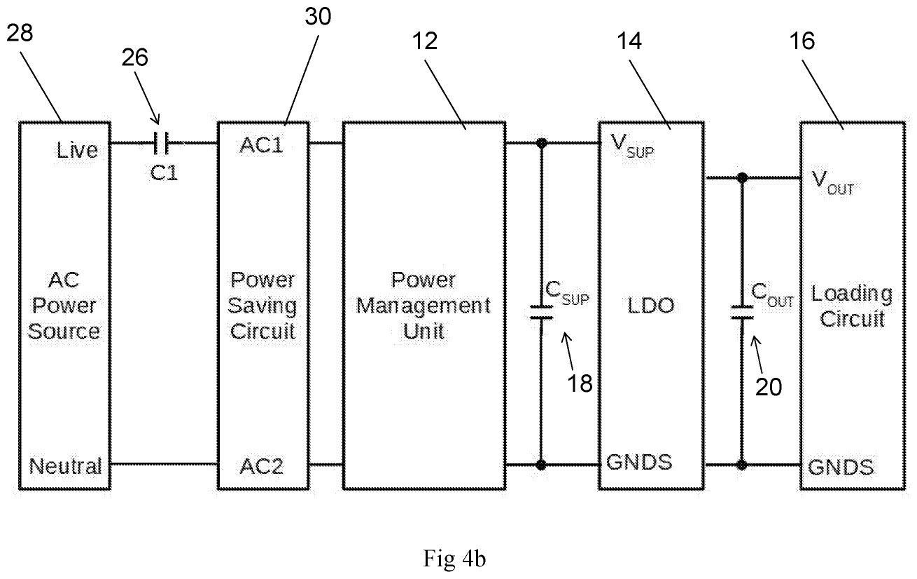

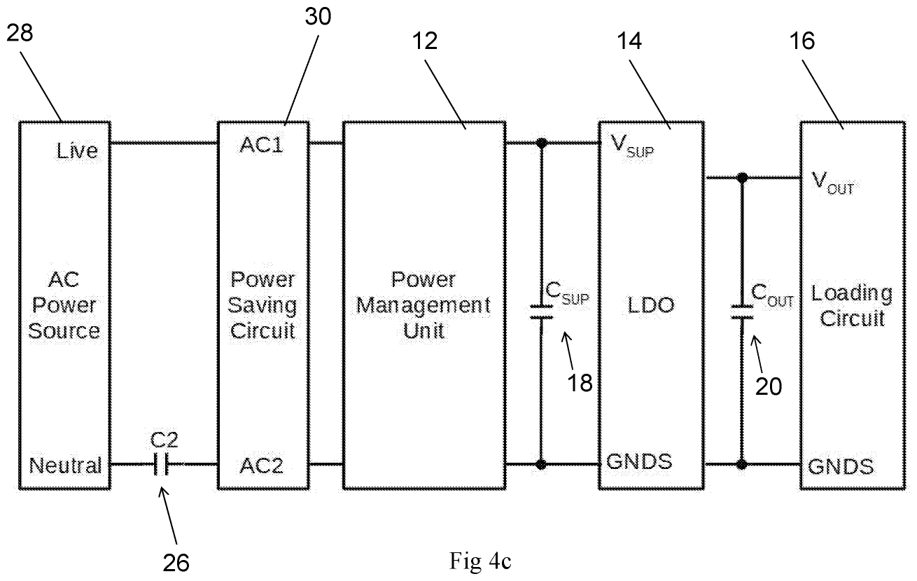

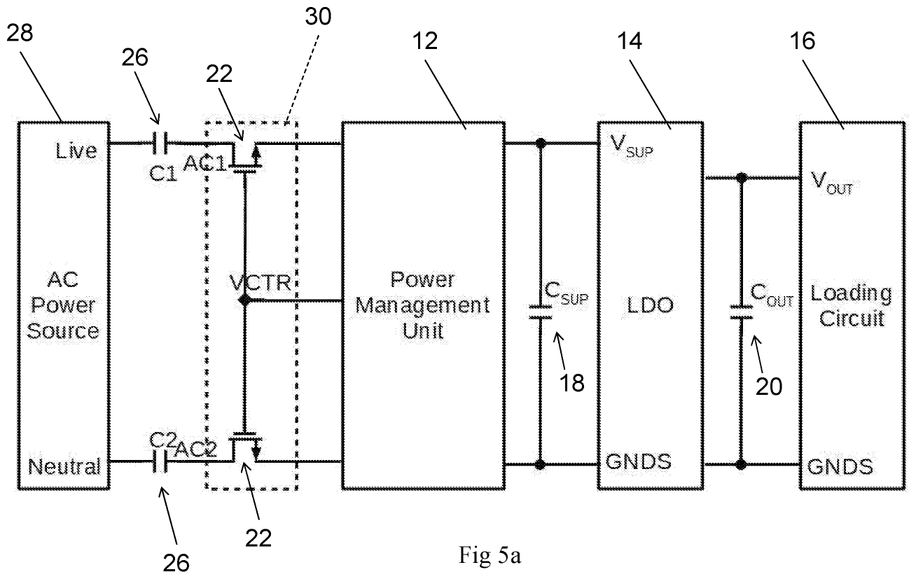

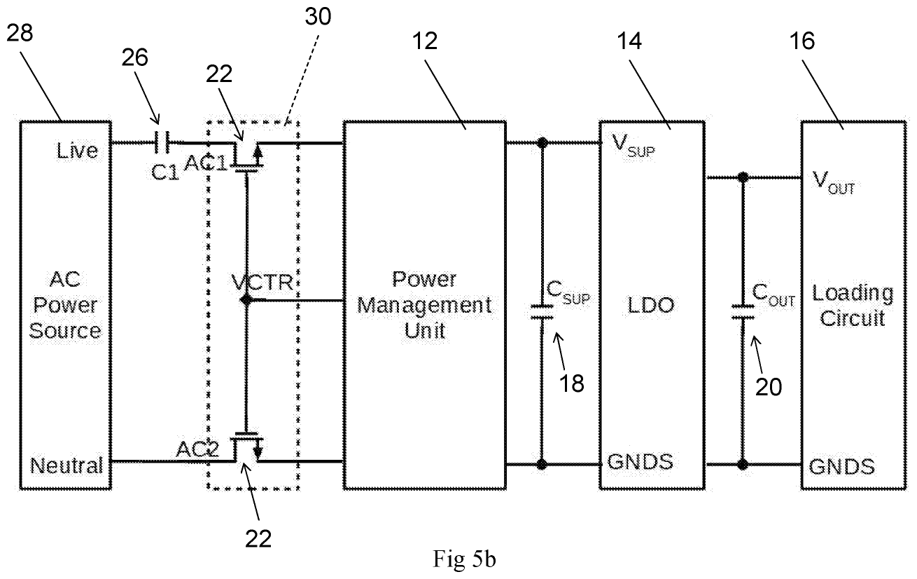

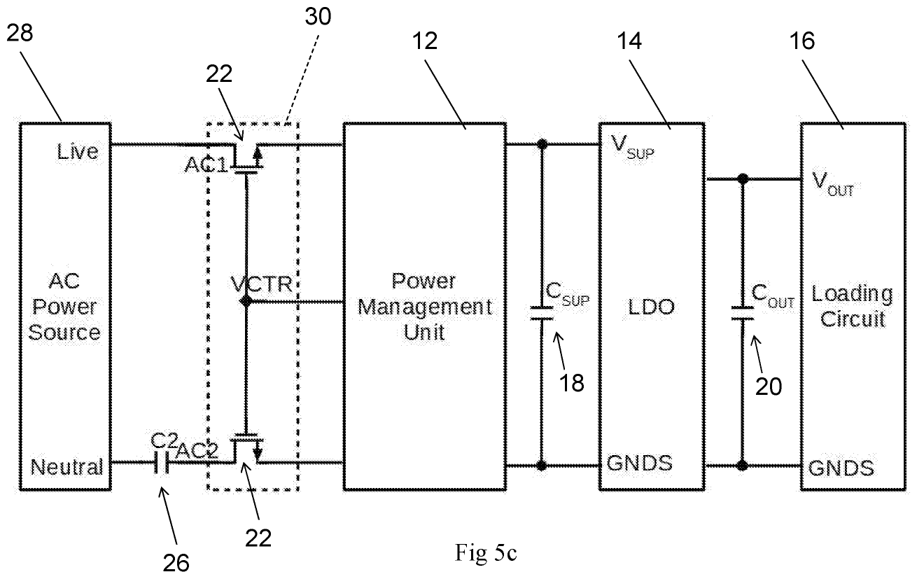

In the application of AC power supply, there are additional AC capacitors 26 between the AC power source 28 and the power saving circuit 30, as shown in FIG. 4a, 4b, 4c. Similar to the case of DC power source, the power saving circuit can be configured with power saving switches 22 in series, as shown in FIG. 5a, 5b, 5c. The working principle is also similar to the case of connecting DC power source. The series power saving switches 22 will be turned OFF when it is in power saving mode while they will be ON when it is in normal mode. The key waveforms, shown in FIG. 3, are the same for both the DC power source and the AC power source: the power switches are ON during start-up. Having reached V_{DDH} and V_{LDO}, the sensing circuit in the PMU will turn OFF the switch to enter the power saving mode. When the V_{SUP} drop to V_{DDL}, the power switches turn ON and let the AC power source to deliver power to the PMU through the AC capacitors 26 and hence charging up the C_{SUP} and CO_{U}T again until V_{SUP} reached V_{DDH}.

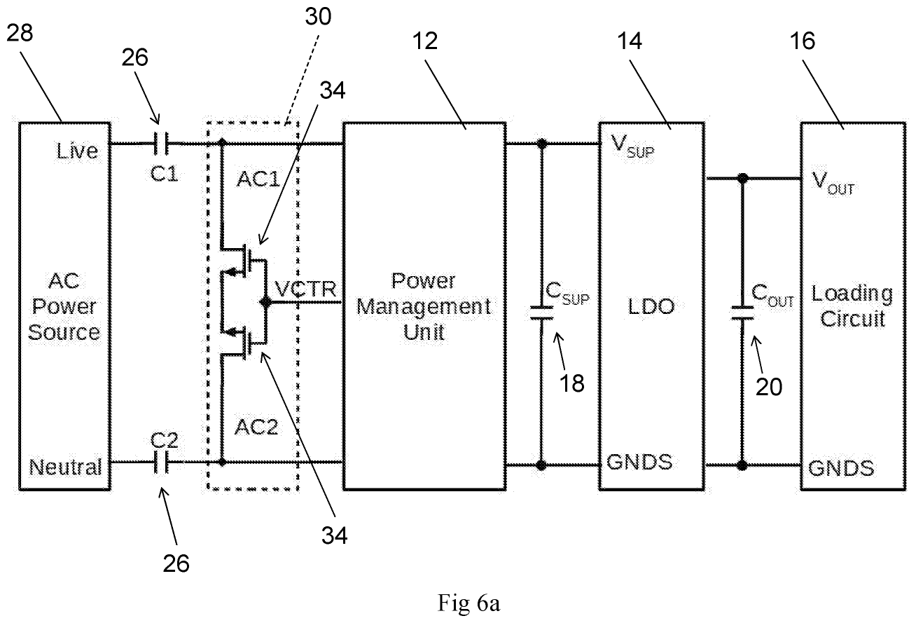

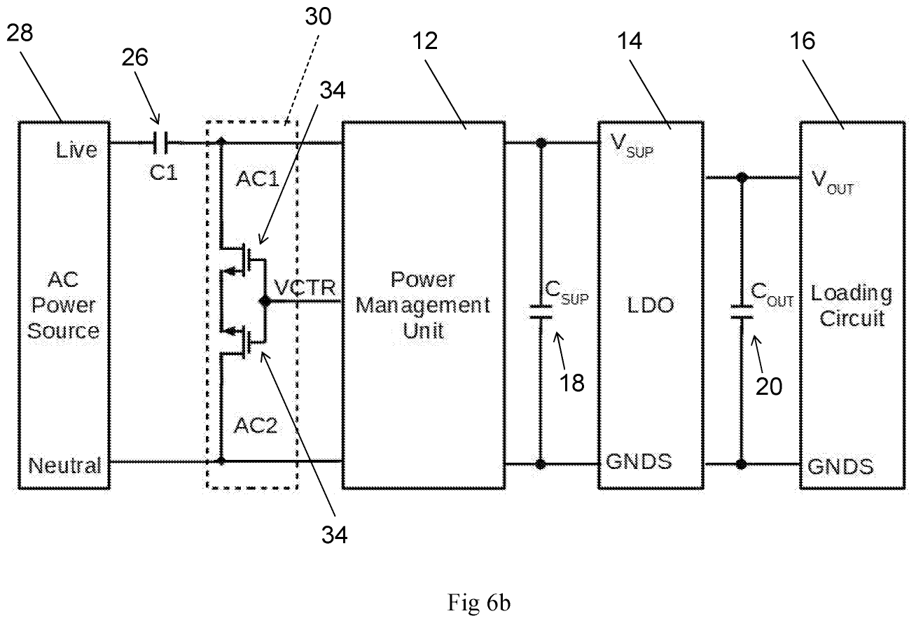

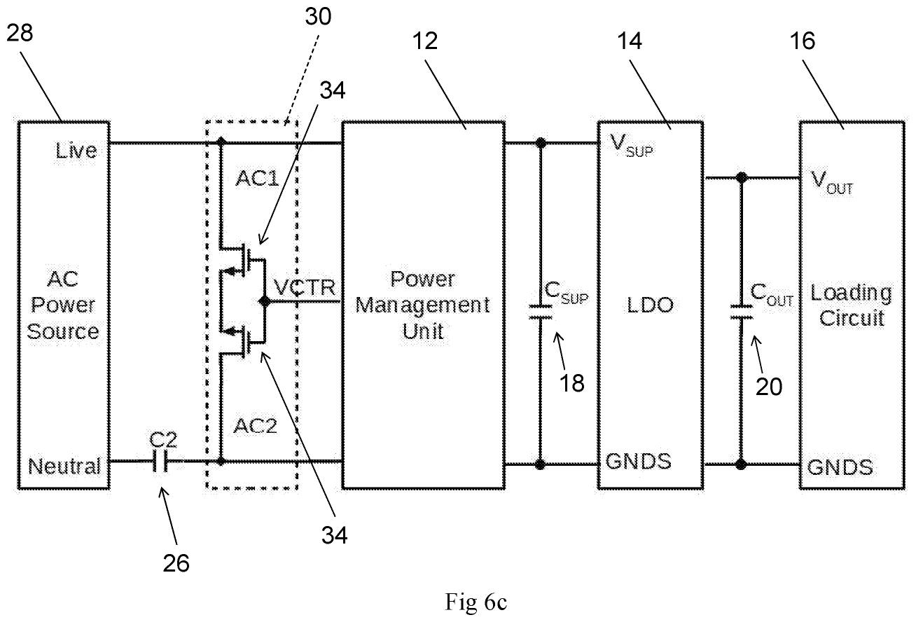

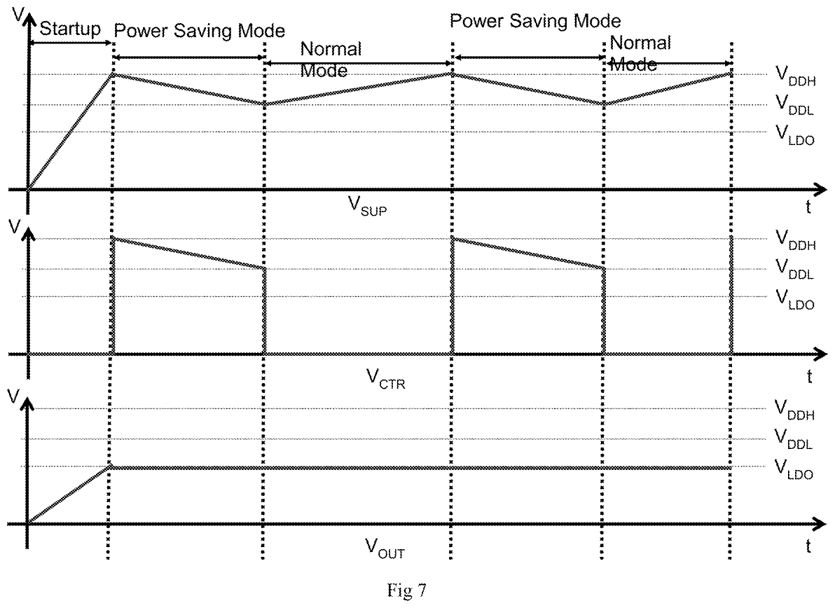

Besides connecting the power switches 22 in series, the power saving circuit can be implemented by shunting power switches 34, as shown in FIG. 6a, 6b, 6c. Similar to the configuration of series power switches, there are two operating mode of the system: normal mode and power saving mode. In normal mode, the power saving switch is OFF and the power transferred from L to one capacitor or two capacitors (depending on which configurations are used), the system and back to N. The sensing circuit keep monitoring the supply voltage to feedback the control signal to the power switches. When the supply voltage of the system, is lower than V_{DDL}, the power switch will be OFF and the power can be transferred to the system to supply power for the PMU 12, the LDO 14 and the loading circuit 16. When the supply voltage of the system is higher than V_{DDH}, the power switch will be ON so that the system enters into power saving mode.

In power saving mode, the power transferred from L to one capacitor or two capacitors (depending on which configurations are used), the power switch and back to N. Because the power transferred to the capacitors is reactive power, it will flow back to the AC power source without any power dissipation. Beside reactive power, the power transferred from L to N will be in real power form because of the parasitic resistors and the ON resistor of the power switches. However, since the power switch is designed to be low resistance, the power dissipated by the ON resistance of the power switch and the equivalent series resistance (ESR) of the capacitors (R_{ESR}) will be small. Therefore, almost all the power from the AC power source will be re-entering to itself and hence achieving power saving. When V_{SUP} drops below V_{DDL}, the power saving switches turn OFF and enable normal mode again. The power from the source transferred to the system again and charging up C_{SUP} back to V_{DD}H and the switching cycle between normal mode and power saving mode is interchangeable depends on the V_{SUP} level of the system.

Because there is a voltage margin between the V_{DDL} and V_{LDO}, the voltage ripple between the V_{DDH} and V_{DDL} will not affect the stability of the V_{LDO}. The proposed architecture can provide low ripple output voltage at V_{LDO} while achieving high efficiency with the power saving switches.

In order to keep the system more robust and minimize the reliability issues, the switches are designed to turn ON or OFF at zero crossing of the AC cycle so as to avoid a sudden change of current amplitude which may damage the switches.

The operating principle is the same for series power switches 22 and the shunting power switches 34 except the power is blocked from entering the system for series configuration instead of flowing back to the AC power source 28 for shunting configuration. The losses of the power saving mode are smaller for series power switches as the power is blocked and no reactive or resistive power going through the system but the series power switches have to be high voltage devices which normally have higher on-resistance. As a result, the efficiency of normal mode operation will be worse than the configuration using shunting power switch. Both topologies served high power efficiency and can be further optimized depending on the loading characteristics. For application with stringent requirement on standby power, configuration with series power saving switches is recommended. On the other hand, application looking for high operating efficiency should employ configuration with shunting power saving switch.

Because the initial condition of the power saving switches in series configuration and shunting configuration are different, the start-up circuit for the power saving switches 22 are not the same, too. The start-up circuit is simpler for the shunting power switches 34 because the system can be powered when the shunting power switches are OFF. However, the series power switches have to be ON to provide power for the system before the system entering the self-contained operating mode, so the start-up circuit have to be designed to turn ON the series power switches by detecting the present of the power source. It can be implemented by edge-triggered power-up circuit because no matter it is DC or AC, there are a ramp-up input to enable the series power saving switches so that the system can gain power to charge up its supply voltage for normal operation.

Generally, the PMU 12 can be other commonly used circuit topologies, but not limited to SMPS, voltage clamping device, charge pump circuit or any combinations amongst different circuit topologies. However, only SMPS, voltage clamping device and charge pump circuit are shown for illustration purpose.

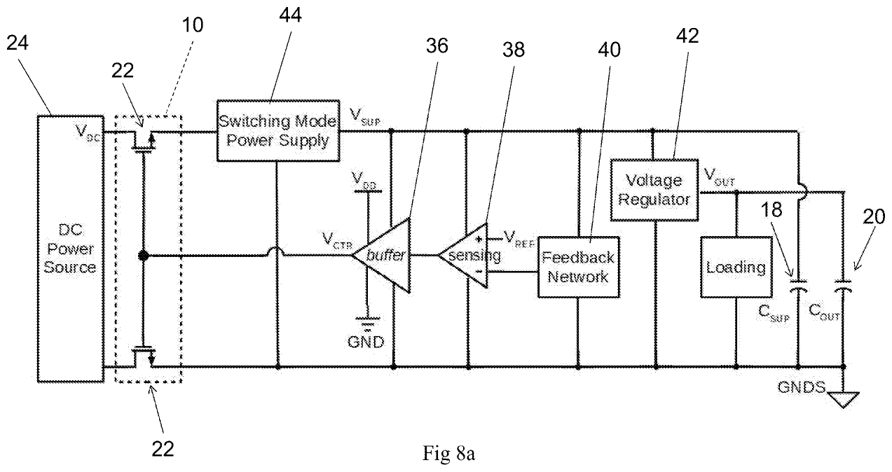

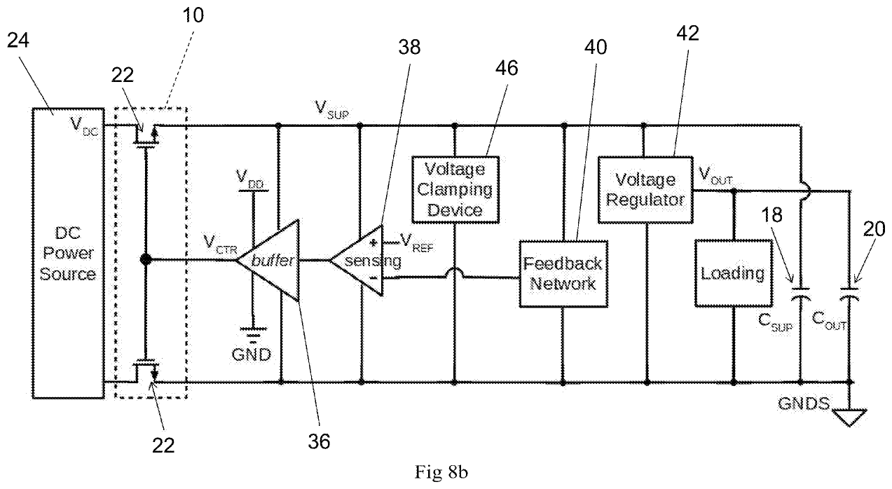

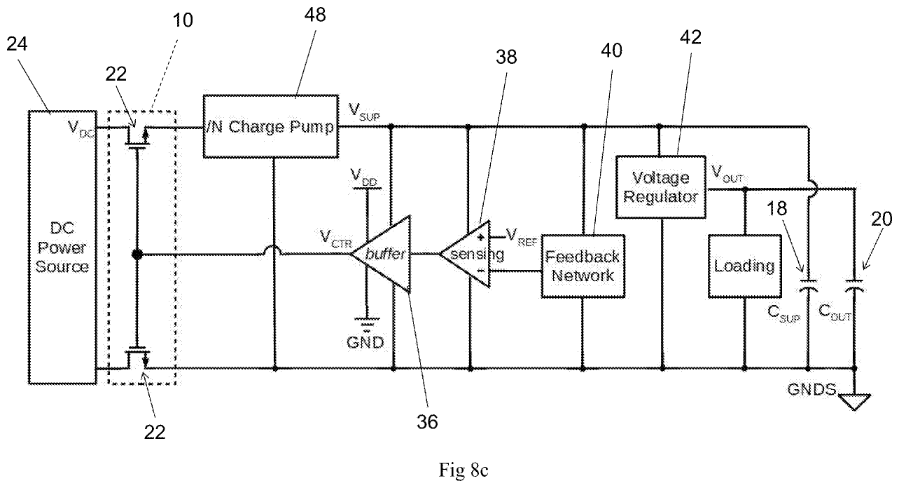

There are 3 common topologies to demonstrate the idea of the adaptive power control when the power source is DC. In FIG. 8a, there are 6 building blocks, namely, 2 series power saving switches 22, a buffer 36, a sensing circuit 38, a feedback network 40, a voltage regulator 42 and a SMPS 44. In FIG. 8b, all other building blocks are the same except the SMPS is replaced by a voltage clamping device 46. In FIG. 8c, all other building blocks are the same except the SMPS is replaced by a divided-by-N charge pump 48.

First of all, the series power saving switches 22 can be any switching devices. In this example, NMOS transistors are used for illustration.

The second block is a buffer 36, that has one input connects to the output of sensing circuit 38 and its output connects to power saving switches 22. The main purpose is to pass the signal at output of sensing circuit 38 to the input of power saving switches 22 without degradation. It isolates capacitive load seen by sensing circuit 38 from power saving switches 22 and enhances driving capability of the sensing circuit. It acts as a level translator in case V_{DD} and V_{SUPX} have different potential. The buffer 36 is optional upon system requirement, it can be by passed with the output of the sensing circuit directly connects to the input of power saving switches. It is assumed that the buffer has unity gain in the following discussion. These systems illustrate a generalized case that the architecture can be supplied by a single supply, where V_{DD} equals to V_{SUP}, or two different supply voltages, V_{DD} and V_{SUP}, depends on system requirement. V_{OUT} is the regulated output voltage, C_{OUT} is the output's decoupling capacitor and output load is connected in parallel with C_{OUT}. C_{SUP} is the supply voltage decoupling capacitor connected in parallel with feedback network.

Thirdly, the sensing circuit 38 can be a comparator with one terminal connected to a reference voltage, Vref, generated by the reference circuit which is not shown in the figure. Another terminal connected to the feedback network which provide the status of the V_{SUP}. The connection can be swapped depending on the circuit configuration as long as the feedback loop is negative.

The feedback network 40 is to provide the information of the V_{SUP} for the sensing circuit 38 to make decision on turning ON or OFF the power saving switches 22. It can be a simple resistor divider in the system to provide scaled potential difference between V_{SUP} and GNDS.

The voltage regulator 42 is to stabilize the V_{SUP} to V_{OUT} so that the ripple voltage at V_{SUP} is suppressed by the voltage regulator. It is necessary for the system because the adaptive power control will create fluctuating V_{SUP} waveform. However, this kind of supply variation may not be suitable for the application requiring clean supply voltage. Hence, the voltage regulator can filter out the supply noise and provide a low ripple output voltage for the loading circuit.

The SMPS 44 can be either a step-up or a step-down converter while the voltage clamping device 46 can be a shunt regulator or a zener diode clamp. The /N charge pump 48 can be a voltage divider.

In the application of AC power source, there are three possible implementations for the proposed architecture with shunting power switches connected in parallel between AC1 and AC2, as shown in FIG. 6a. The power saving switches connected between AC1 and AC2 while 2 capacitors connected between L and AC1 and between N and AC2 respectively. In FIG. 6b, the power saving switches connected between AC1 and neutral (N) with one capacitor connected between live (L) and AC1. In FIG. 6c, the power saving switches connected between L and AC2 with one capacitor connected between AC2 and N. For simplicity, the topology of FIG. 6a will be further elaborate only. Other configurations operate with the same principle as its of FIG. 6a.

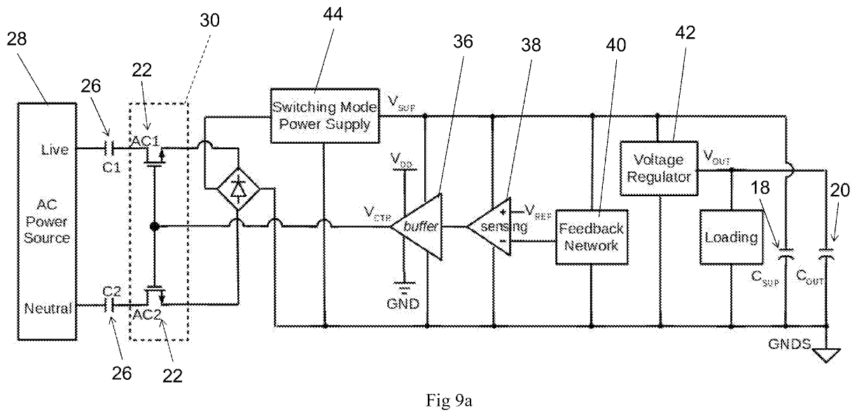

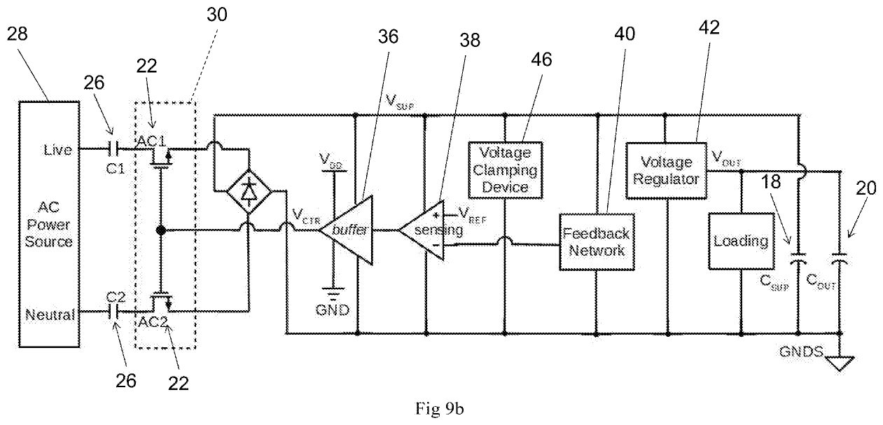

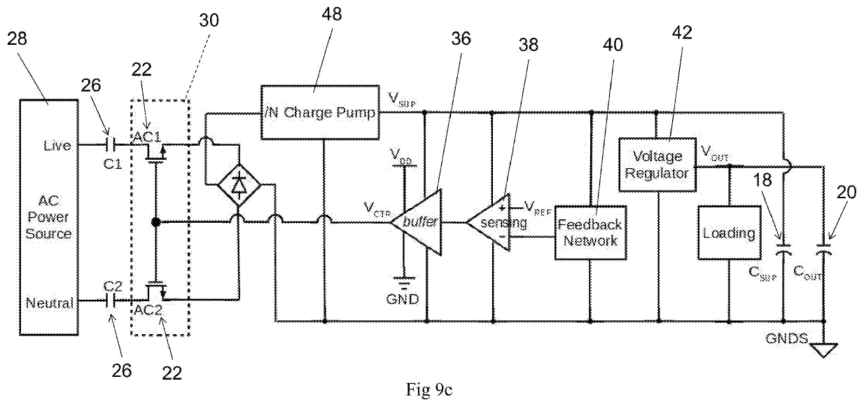

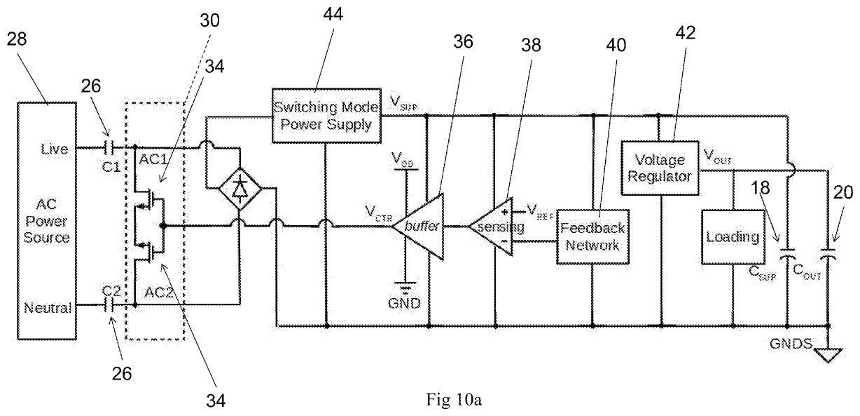

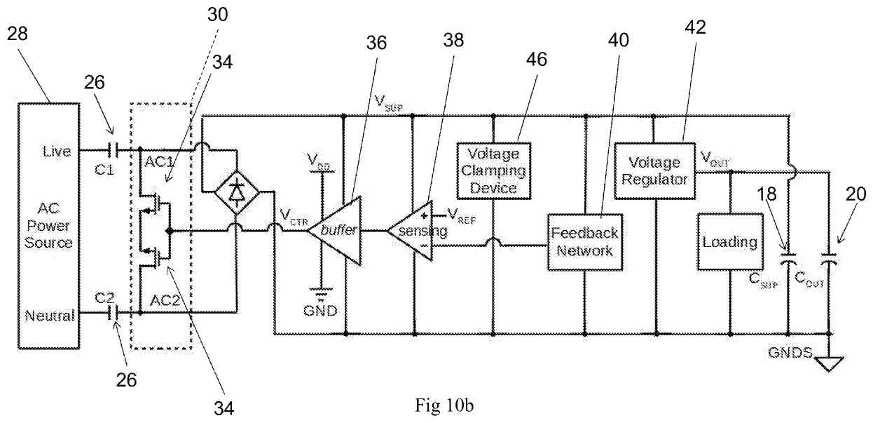

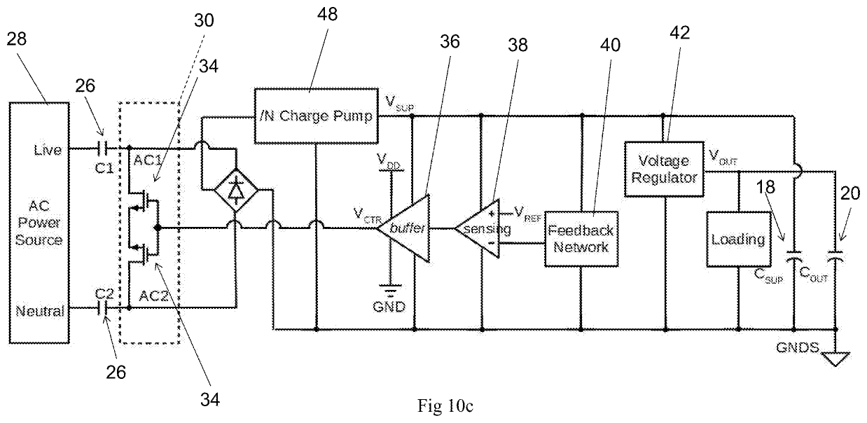

FIGS. 9 and 10 demonstrate the typical systems for the adaptive power control circuit for AC power source.

Because of AC application, an extra building blocks, a diode bridge is needed to rectify the AC voltage into positive voltage level. The positive voltage level can be approximated to an incremental DC voltage level instantaneously so that the operation can be understood similarly to that of the DC case. Other building blocks are the same for both AC and DC applications.

The SMPS 44 can be an AC to DC step-down converter while the voltage clamping device 46 can be a capacitive dropper, a shunt regulator or a zener clamping device. For the/N charge pump 48, it can be a divided-by-2 charge pump or a divided-by-4 charge pump.

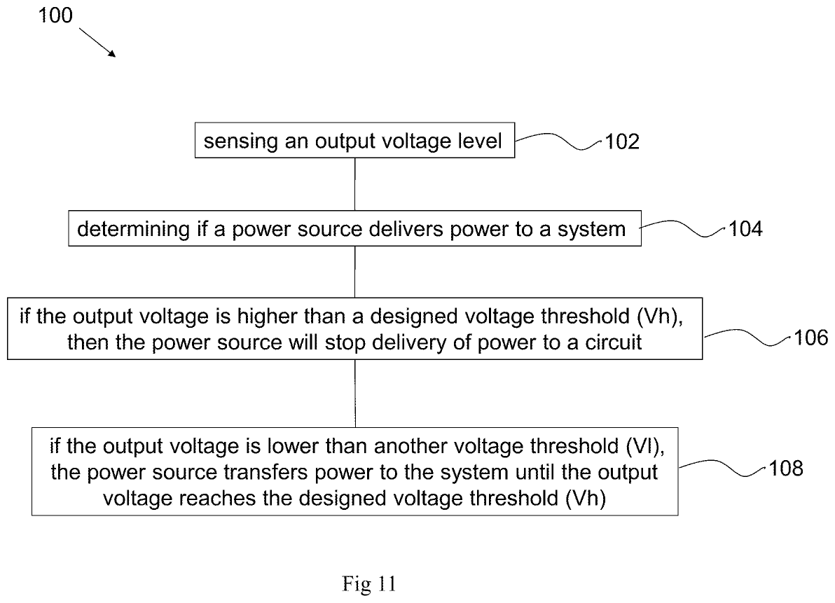

FIG. 11 illustrates a method 100. The method 100 includes sensing an output voltage level (at block 102). Determining if a power source delivers power to a system (at block 104). Wherein, if the output voltage is higher than a designed voltage threshold (Vh), then the power source will stop delivery of power to a circuit (at block 106). Wherein, if the output voltage is lower than another voltage threshold (Vl), the power source transfers power to the system until the output voltage reaches the designed voltage threshold (Vh) (at block 108). It should be noted that the illustration of a particular order of the blocks does not necessarily imply that there is a required or preferred order for the blocks and the order and arrangement of the blocks may be varied. Furthermore, it may be possible for some blocks to be omitted.

Below are provided further descriptions of various non-limiting, exemplary embodiments. The below-described exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

In one exemplary embodiment, an adaptive power control method with circuit example to demonstrate keeping low standby power while maintaining output driving capability and minimize wake up time. The adaptive power control method senses the output voltage level to determine whether the power source should deliver power to the system or not. If the output voltage is higher than a designed voltage threshold, Vh, then the power source will stop delivery power to the circuit. On the other hand, when the output voltage is lower than another voltage threshold, Vl, the power source transfer power to the system again until the output voltage reached the designed voltage threshold (Vh).

A method as above wherein the power source is a DC power source.

A method as above wherein the power source is an AC power source.

A method as above wherein sensing the output voltage level further comprises sensing the output voltage level with a sensing circuit.

A method as above wherein the sensing circuit is connected to a feedback network, wherein power switches are connected to the power source, and wherein the feedback network is configured to provide information for the sensing circuit to make a decision on turning ON or OFF the power switches.

A method as above wherein the sensing circuit is connected between a buffer and a feedback network.

A method as above wherein the sensing circuit is connected the power source with power switches therebetween.

A method as above wherein a capacitor is provided between one of the power switches and the power source.

A method as above wherein the power switches comprise shunting power switches.

In another exemplary embodiment, an adaptive power control circuit comprising: a sensing circuit; a voltage regulator connected to the sensing circuit; and a feedback network connected between the sensing circuit and the voltage regulator; wherein the sensing circuit, the voltage regulator, and the feedback network are configured to cause the adaptive power control circuit to: sense an output voltage level; determine if a power source delivers power to a system; wherein if the output voltage is higher than a designed voltage threshold (Vh), then the power source will stop delivery of power; and wherein if the output voltage is lower than another voltage threshold (Vl), the power source transfers power to the system until the output voltage reaches the designed voltage threshold (Vh).

An adaptive power control circuit as above wherein the power source is a DC power source.

An adaptive power control circuit as above wherein the power source is an AC power source.

An adaptive power control circuit as above wherein power switches are connected to the power source, and wherein the feedback network is configured to provide information for the sensing circuit to make a decision on turning ON or OFF the power switches.

An adaptive power control circuit as above wherein the power switches comprise series power switches.

An adaptive power control circuit as above wherein the power switches comprise shunting power switches.

An adaptive power control circuit as above further comprising a buffer connected to the sensing circuit.

An adaptive power control circuit as above further comprising a switching mode power supply.

An adaptive power control circuit as above further comprising a voltage clamping device.

An adaptive power control circuit as above further comprising a charge pump.

According to some exemplary embodiments, a controller may be provided which comprises a microprocessor coupled to a memory, such as on a printed circuit board for example. The memory could include multiple memories including removable memory modules for example.

It should be understood that components of the invention can be operationally coupled or connected and that any number or combination of intervening elements can exist (including no intervening elements). The connections can be direct or indirect and additionally there can merely be a functional relationship between components.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

1. A method comprising:
sensing an output voltage level;
determining if a power source delivers power to a system;
wherein if the output voltage is higher than a designed voltage threshold (Vh), then the power source will stop delivery of power to a circuit; and
wherein if the output voltage is lower than another voltage threshold (Vl), the power source transfers power to the system until the output voltage reaches the designed voltage threshold (Vh).

2. The method of claim 1, wherein the power source is a DC power source.

3. The method of claim 1, wherein the power source is an AC power source.

4. The method of claim 1, wherein sensing the output voltage level further comprises sensing the output voltage level with a sensing circuit.

5. The method of claim 4 wherein the sensing circuit is connected to a feedback network, wherein power switches are connected to the power source, and wherein the feedback network is configured to provide information for the sensing circuit to make a decision on turning ON or OFF the power switches.

6. The method of claim 4 wherein the sensing circuit is connected between a buffer and a feedback network.

7. The method of claim 4 wherein the sensing circuit is connected the power source with power switches therebetween.

8. The method of claim 7, wherein a capacitor is provided between one of the power switches and the power source.

9. The method of claim 7, wherein the power switches comprise shunting power switches.

10. An adaptive power control circuit comprising:
a sensing circuit;
a voltage regulator connected to the sensing circuit; and
a feedback network connected between the sensing circuit and the voltage regulator;
wherein the sensing circuit, the voltage regulator, and the feedback network are configured to cause the adaptive power control circuit to:
sense an output voltage level;
determine if a power source delivers power to a system;
wherein if the output voltage is higher than a designed voltage threshold (Vh), then the power source will stop delivery of power; and
wherein if the output voltage is lower than another voltage threshold (Vl), the power source transfers power to the system until the output voltage reaches the designed voltage threshold (Vh).

11. The adaptive power control circuit of claim 10, wherein the power source is a DC power source.

12. The adaptive power control circuit of claim 10, wherein the power source is an AC power source.

13. The adaptive power control circuit of claim 10 wherein power switches are connected to the power source, and wherein the feedback network is configured to provide information for the sensing circuit to make a decision on turning ON or OFF the power switches.

14. The adaptive power control circuit of claim 13 wherein the power switches comprise series power switches.

15. The adaptive power control circuit of claim 13 wherein the power switches comprise shunting power switches.

16. The adaptive power control circuit of claim 10 further comprising a buffer connected to the sensing circuit.

17. The adaptive power control circuit of claim 10 further comprising a switching mode power supply.

18. The adaptive power control circuit of claim 10 further comprising a voltage clamping device.

19. The adaptive power control circuit of claim 10 further comprising a charge pump.
